(19) United States
(12) Patent Application Publication
(10) Pub. No.: US 2026/0084832 A1
(43) Pub. Date: Mar. 26, 2026

(54) METHOD AND SYSTEM OF AUTOMATICALLY INFORMING AN AIRCREW OF A ROOT CAUSE OF AN ALERT FOR AN AIRCRAFT

(71) Applicant: HONEYWELL INTERNATIONAL INC., Charlotte, NC (US)

(72) Inventors: Karthikeyan M, Madurai (IN); Gobinathan Baladhandapani, Madurai (IN); Srilakshmi Kurudi, Bangalore (IN); Pradeep Huncha, Bangalore (IN)

(73) Assignee: HONEYWELL INTERNATIONAL INC., Charlotte, NC (US)

(21) Appl. No.: 18/897,544

(22) Filed: Sep. 26, 2024

(51) Int. Cl. B64D 45/00

(52) U.S. Cl. CPC B64D 45/00; B64D 2045/0085

(57) ABSTRACT

A method includes receiving, by at least one processor, an indication of an alert to announce on an vehicle to inform a pilot on the vehicle of an undesirable event associated with the vehicle, and automatically determining, by at least one processor, an immediate cause of the alert. The method also includes automatically determining, by at least one processor, root cause mismatch data that indicates conditions that formed the immediate cause of the alert. The mismatch data comprises a mismatch of vehicle data between data related to an expected action or inaction of the vehicle and data related to an actual action or inaction of the vehicle. The method also includes providing the mismatch data to automatically generate a message indicating the mismatch and to announce the message on the vehicle.

### TECHNICAL FIELD

The subject matter described herein generally relates to vehicles, and more particularly, to aircraft alert systems.

### BACKGROUND

During a flight of an aircraft, safety systems on the aircraft provide many different types of alerts displayed to an aircrew or pilot so that the aircrew can make a timely correction to avoid an undesirable or hazardous event. When the reason for the alert is ambiguous, the aircrew must spend time performing manual root cause analysis (RCA) to determine the reason for the alert so that an appropriate reaction can be executed that compensates for, or corrects, the cause of the alert. This may include reviewing a flight checklist, an aircraft manual airplane flight manual (AFM), aircraft specifications, performance data (or data indicating a state of the aircraft) displayed to the aircrew, avionics system descriptions, flight plan constraints, and so forth. The duration to determine the cause of the alert increases when multiple reasons for the same alert can exist. Also, the duration to determine the cause of the alert and then make corrections may become even more important for single pilot aircraft and/or during certain complicated procedures such as takeoff, landing, ‘go arounds,’ and ‘engine out’ situations versus simply cruising. Thus, it is desirable to reduce the workload and shorten the duration for determining a root cause of the alert in time for an aircrew to make corrections during a flight.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one implementation, a method includes receiving, by at least one processor, an indication of an alert to announce on a vehicle to inform a user on the vehicle of an undesirable event associated with the vehicle, and automatically determining, by at least one processor, an immediate cause of the alert. The method also includes automatically determining, by at least one processor, root cause mismatch data that indicates conditions that formed the immediate cause of the alert. The mismatch data comprises a mismatch of vehicle data between data related to an expected action or inaction of the vehicle and data related to an actual action or inaction of the vehicle. The method also includes providing the mismatch data to automatically generate a message indicating the mismatch and to announce the message on the vehicle.

In another implementation, a vehicle includes a display device to display alerts, and processor circuitry forming at least one processor arranged to operate by: generating an indication of an alert of an undesirable event associated with the vehicle, announcing the alert on the display device, and automatically determining an immediate cause of the alert. The processor is also arranged to operate by automatically determining root cause mismatch data that indicates conditions that formed the immediate cause of the alert. The mismatch data comprises a mismatch of vehicle data between data related to an expected action or inaction of the aircraft and data related to an actual action or inaction of the vehicle. The processor is also arranged to operate by automatically announcing a message indicating the mismatch and on the display device of the vehicle.

In yet another implementation, a system includes a vehicle that comprises a display device to display alerts, and first processor circuitry forming at least one first processor arranged to operate by: generating an indication of an alert of an undesirable event associated with the aircraft, announcing the alert on the display device, and automatically transmitting the indication of the alert and basis data used to trigger the alert. A remote system remote from the vehicle includes memory, and second processor circuitry forming at least one second processor communicatively coupled to the memory, and being arranged to operate by: receiving the indication and the basis data, and automatically determining root cause mismatch data that indicates conditions that formed an immediate cause of the alert and by using the alert and the basis data. The mismatch data comprises a mismatch of vehicle data between data related to an expected action or inaction of the aircraft and data related to an actual action or inaction of the vehicle, and the second processor to operate by transmitting a message or message data to be used to generate the message and indicating the mismatch. The at least one first processor at the vehicle is arranged to operate by receiving the message or message data, and displaying the message on the display device indicating the mismatch.

Furthermore, other desirable features and characteristics of the subject matter described herein will become apparent from the subsequent detailed description and the appended claims, taken in conjunction with the accompanying drawings and the preceding background.

### BRIEF DESCRIPTION OF THE DRAWINGS

The present disclosure will hereinafter be described in conjunction with the following drawing figures, wherein like numerals denote like elements, and wherein:

FIG. 1 is a schematic diagram of an example system to operate a method of automatically informing an aircrew of a root cause of an alert for an aircraft according to at least one of the implementations described herein;

FIG. 2 is a schematic diagram of example safety systems to provide alerts on an aircraft according to at least one of the implementations described herein;

FIG. 3 is a schematic diagram of example root cause analysis and contextual information units used in the system of FIG. 1 according to at least one of the implementations described herein;

FIGS. 4A-4B is a flow chart of a method of automatically informing an aircrew of a root cause of an alert for an aircraft according to at least one of the implementations described herein;

FIG. 5 is a schematic diagram of an example root cause mismatch tree for a pull-up alert according to at least one of the implementations described herein;

FIG. 6 is a schematic diagram of an example root cause mismatch tree for auto-pilot alerts according to at least one of the implementations described herein;

FIG. 7 is a schematic diagram of an example avionics display showing an example alert window with mismatch information and contextual information messages related to an alert according to at least one of the implementations described herein;

FIG. 8 is a schematic diagram of an example avionics flight planning page of an FMS showing example reasons of an example alert according to at least one of the implementations described herein; and

FIG. 9 is a schematic diagram of another example avionics display showing an example alert window with mismatch information and contextual information messages related to an alert according to at least one of the implementations described herein.

### DETAILED DESCRIPTION

The disclosed system and method provides automatic root cause analysis when an alert is provided to an aircrew on an aircraft, and then displays the root cause of the alert to the aircrew on-board the aircraft. The reasons for an alert are described herein as immediate causes and root causes. An immediate cause is the direct reason for an alert, while the root cause is the reason for the conditions that caused the immediate cause. Thus, for example, an aircraft descending below an altitude constraint may be an immediate cause for a “pull up” alert, while determining that a pilot input a mistaken altitude target value into an avionics system or a flight management system (FMS) that caused the aircraft to descend is the root cause of the alert. The term ‘pilot’ as used herein collectively refers to any one or more members of an aircrew on an aircraft including co-pilots, and these terms may be used interchangeably.

The root cause or root cause information may be referred to herein as mismatch information or data that causes the conditions of the immediate cause of the alert and generally refers to a mismatch between expected action by the aircraft evidenced by input or understood control, navigation, or other flight related or sensed values or information, and actual action of the aircraft that causes the alerts based on actual control, navigational, or other flight related or sensed values or information. The mismatch information or data is displayed to an aircrew using messages including avionic descriptions, text, or codes for easy understanding of the root causes for the aircrew.

By one form, determining mismatch information or data is accomplished by operating a root cause mismatch tree, which is similar to a fault tree analysis and by using a root cause mismatch tree database to perform automatic root cause analysis. The root cause mismatch tree may be preset or pre-trained with all or substantially all known possible root causes of each or individual immediate faults (or immediate causes) that cause an alert. Alerts may be provided for terrain awareness, traffic collision avoidance, flight control, system malfunction alerts, altitude and speed alerts, cabin alerts, and so forth. The root causes can be categorized as technical failures, procedural issues, and human errors. Technical failures refer to malfunctions or defects in aircraft systems and components, such as avionics equipment or mechanical parts. Procedural issues cover lapses in adherence to established protocols or guidelines during flight operations. Human error can be divided into sub-categories such as mistaken inputs by the aircrew into avionics systems, where incorrect data entry or settings adjustments (or omitted entries that permit a default value to be input instead) lead to alerts, and mistaken control settings in the cockpit, where improper manipulation of controls or switches may trigger alerts. The root cause mismatch tree may be set up or trained to recognize any of these alert categories and root causes. Thus, at least some of the leaves or basic event nodes of the root cause mismatch tree are related to human error such as avionics system target inputs. For example, a target altitude or altitude range may be received as input from a pilot and by an avionics system (or omitted and a default value is input). Thus, in one perspective, the root cause analysis and root cause mismatch tree analysis inherently attempts to determine the intent of the aircrew (for example, what the aircrew meant to input or set on the avionics systems of the aircraft for these human error examples).

The root cause mismatch tree analysis may be performed remotely from the aircraft such as at a remote system or ground maintenance or control center by using transmissions of root cause data between the aircraft and the remote system. Also, the remote system may retrieve data from sources external to the aircraft directly, and need not retrieve all data from the aircraft. Thus, an airport or ATC may broadcast certain flight-related data, such as a QNH (atmospheric pressure to be used for amplitude setting) as one example.

By another option, contextual information also is displayed to the aircrew and that lists data relevant to the alert and mismatch information including a list of identifiers and corresponding data values, such as a current state of the aircraft (for example, an altitude) and a current altitude constraint, as one example. This feature gathers information from various avionics systems that an aircrew “would have” reviewed to determine the root cause of an alert manually, and gathers the information and lists the contextual information at one or a few locations for easy and fast review of the information by the aircrew.

By one example form, the alert, mismatch information, and contextual information (when present) are displayed on the display or avionics page or image that is most relevant to the alert. Thus, an alert related to altitude may be shown on a display with a vertical profile, and so forth.

This arrangement of automatic root cause analysis with a root cause mismatch tree, and display of mismatch and contextual information significantly reduces the workload of an aircrew and saves a substantial amount of time to determine the root cause of the alert from a duration typically counted in minutes to mere seconds. This permits the aircrew to take corrective action much faster when needed. Thus, the disclosed method and system provides time for increased situational awareness and safety, and while using a remote system, such as a cloud-based system, which can provide sufficient computing and memory capacity, and transmission and computing bandwidth needed to perform the root cause analysis.

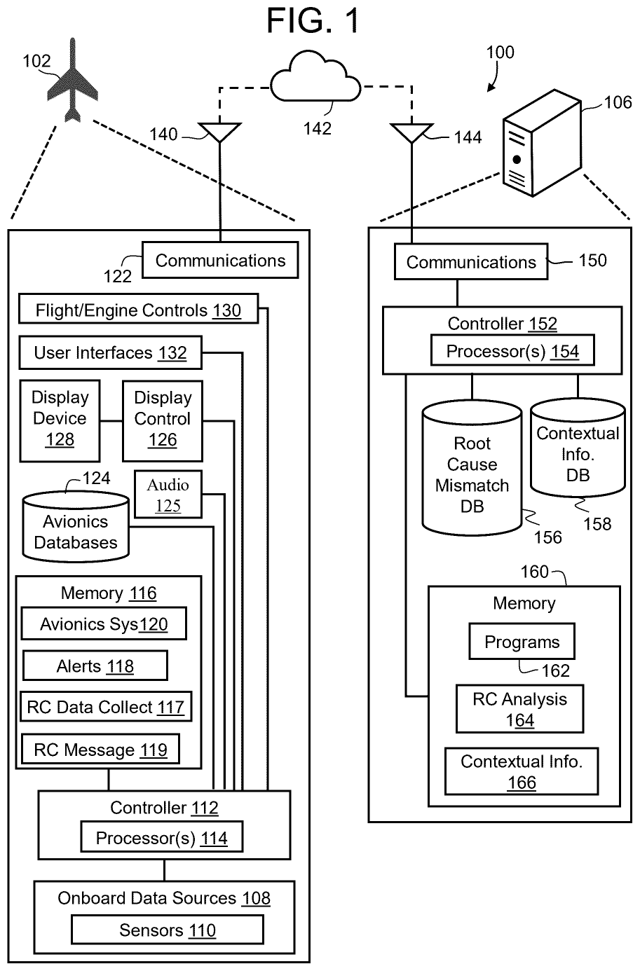

Referring now to FIG. 1, an example aircraft system, here being an alert root cause analysis communication system 100 (or just system 100), is illustrated in accordance with the example implementations herein. The system 100 includes at least one aircraft 102 and at least one remote system 106 also referred to herein as a root cause analysis (RCA) base. The aircraft 102 may include any number and type of aircraft and is not particularly limited as long as the aircraft has the systems to adequately operate the root cause analysis methods described herein.

It will be appreciated, however, that while the present examples describe the method and system herein for an aircraft, the present methods and systems may be used for vehicles other than an aircraft, such as land craft including automobiles or trucks and so forth, watercraft, and space craft, etc., as long as the vehicle has sensors and safety systems for activating alerts, transmitting the alert data for analysis at a remote system, and receiving and displaying messages relating to the alert as described herein.

The aircraft 102 may include a controller 112 operationally coupled to computer-readable storage media and/or memory 116, onboard data sources 108 including, for example, an array of sensors 110, and a communications system 122 that is or has a gateway and an antenna 140, which may wirelessly transmit data to and receive data from various external sources physically and/or geographically remote to the aircraft 102 such as the remote system 106. The aircraft 102 also may have at least one avionics database 124, an audio system or panel 125 to announce alerts for example, at least one display control unit 126 that controls at least one display device 128, at least one user interface 132, and flight controls and engine controls 130.

The remote system 106 may include a controller 152 operationally coupled to computer-readable storage media or memory 160, one or more databases including at least one remote root cause mismatch database 156 and a contextual information database 158, a communications system 150 that is or has a gateway and includes an antenna 144, which may wirelessly transmit data to and receive data from various external sources physically and/or geographically remote to the remote system 106, such as the aircraft 102 and other aircraft or ground locations.

Although schematically illustrated in FIG. 1 as a single unit, the individual elements and components of the system 100 can be implemented in a distributed manner utilizing any practical number of physically distinct and operatively interconnected pieces of hardware or equipment.

The term “controller,” as appearing herein, broadly encompasses those components used to perform or otherwise support the processing functionalities of the system 100. Accordingly, the controllers 112 and 152 can encompass or may be associated with circuitry forming any number of individual processors, computer-readable memories, power supplies, storage devices, interface cards, and other standardized or customized components.

In various implementations, each of the controllers 112 and 152 include processor circuitry forming at least one processor 114 and 154 respectively, a communication bus, and a computer readable storage device or media. The processors 114 and 154 perform the computation and control functions of the controller 112 or 152. The processors 114 and 154, and the controllers 112 and 152 may form or be part of an avionics server or gateway server. The processors 114 and 154 can be any custom made or commercially available processors, a general purpose processor, a central processing unit (CPU), a graphics processing unit (GPU), a digital signal processor (DSP), an auxiliary processor among several processors associated with the controller 112 or 152, a semiconductor-based microprocessor (in the form of a microchip, chip set, system on a chip (SoC)), a microcontroller, multiple processor cores, an application specific integrated circuit (ASIC), a field programmable gate array (FPGA) or other programmable logic device, discrete gate or transistor logic, discrete hardware components, a content addressable memory, or any combination thereof designed to perform the functions described herein. By one form, the controller 152 at the remote system 106 may have one or more processors 154 and other computing components on one or more servers, computers, laptops, desktops, and/or mobile devices such as tablets, smartphones, and so forth, and this may include cloud-based servers. In this regard, the remote system 106 may be realized as a remote maintenance or control center (or an alert RCA center) or a distributed network of remote centers that reside at geographic locations that are separate and distinct from one or more edge computing systems that communicate directly with the controller 112 on the aircraft 102. Thus, the processors 114 and 154 are formed by hardware, processor circuitry, processing logic, and/or other components in any combination arranged to facilitate communications and/or interaction between the elements of the system 100 and perform additional processes, tasks and/or functions to support operation of the system 100, as described in greater detail below.

The memories 116 and 160 may include computer readable storage devices or media such as volatile and nonvolatile storage in read-only memory (ROM), random-access memory (RAM), flash memory, registers, and cache. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 112 or 152. The bus may serve to transmit programs, data, status and other information or signals between the various components coupled to the controller 112 or 152. The bus can be any suitable physical or logical means of connecting computer systems and components. This includes, but is not limited to, direct hard-wired connections, fiber optics, infrared, and wireless bus technologies.

The executable instructions may include or establish one or more separate programs, each of which comprises an ordered listing of executable instructions for implementing logical functions. The instructions, when executed by the processor, perform logic, calculations, methods and/or algorithms, and generate data based on the logic, calculations, methods, and/or algorithms. Although only one of each of the controllers 112 and 152 are shown in FIG. 1, implementations of the system 100 can include any number of controllers 112 and 152 that communicate over any suitable communication medium or a combination of communication media and that cooperate to perform logic, calculations, methods, and/or algorithms, and generate data. In various implementations, the controllers 112 and 152 each include or cooperate with at least one firmware and software program (generally, computer-readable instructions that embody an algorithm) for performing the various process tasks, calculations, and control/display functions described herein. During operation, each of the controllers 112 and 152 may be programmed with and execute at least one firmware or software program or system. By one form, memory 116 on the aircraft 102 may have root cause data collection unit 117, an alerts unit 118, a root cause message program or unit 119, avionics systems 120, and other programs. The memory 160 at the remote system 106 may have a root cause analysis unit 164, a contextual information unit 166, and other programs 162. These programs or units (or systems or modules) may embody one or more algorithms, to thereby perform the various process operations, tasks, calculations, and control/display functions described herein. The memory 160 and/or databases 156, 158 mentioned herein may store root cause mismatch tree structure templates for use by the root cause analysis unit 164 at the remote system 106.

Each of the controllers 112 and 152 may exchange data with one or more external sources to support operation of the system 100 in various implementations. In this case, bidirectional wireless data exchange may occur via the communications systems 122 and 150 over a communications network 142, such as a public or private network implemented in accordance with Transmission Control Protocol/Internet Protocol architectures or other conventional protocol standards. Encryption and mutual authentication techniques may be applied, as appropriate, to ensure data security.

In various implementations, each of the communication systems 122 and 150 are configured to support instantaneous (i.e., real time or current) communications between various systems. The communication systems 122 and 150 may each incorporate one or more transmitters, receivers, and the supporting communications hardware and software required for components of the system 100 to communicate as described herein. The network 142 used for communication may be a wireless gateway such as a data link management wireless (DLM-W) system that provides communication among systems within a cockpit and on an aircraft as well as transmission between the aircraft and the ground, Aircraft Communication Addressing and Reporting System (ACARS), which uses VHF, HF, or satellite communication (SATCOM) (whether via Wi-Fi or other network), VHF Data Link (VDL), High-Frequency Data Link (HFDL), and air-to-ground (ATG) systems. Other networks may be used when the aircraft 102 is on the ground such as cellular networks and ground Wi-Fi Networks while an aircraft is at a gate, taxiing, or at a remote location on the ground from a specific maintenance base. Any combination of these may be used. In various implementations, one or both the communications systems 122 and 150 may include additional communications not directly relied upon herein, such as bidirectional pilot-to-ATC (air traffic control) communications via a datalink, and any other suitable radio communication system that supports communications between the aircraft 102, the remote system 106, and various external source(s).

Each of the memories 116 and 160 can encompass any number and type of storage media suitable for storing computer-readable code or instructions, such as the programs, systems, units, and/or modules at the memories 116 and 160, as well as other data generally supporting the operation of the system 100. As can be appreciated, each of the memories 116 and 160 may be part of their respective controller 112 or 152, separate, or both.

In the example of system 100 where the root cause analysis takes place at the remote system 106, the avionics databases 124 are provided for operating the aircraft, while the remote system 100 may have at least the root cause mismatch database 156 and the contextual information database 158 to provide data for alert event analysis and to generate messages to display on the aircraft 102. It will be appreciated that by other alternative approaches, however, that the root cause analysis and message data generation, as well as the associated databases, may be located on the aircraft instead when the aircraft has a sufficient amount or processor capacity, memory and bandwidth on the aircraft. Also, the databases 156 and 158 may be located at both locations when desired.

Continuing with the example system 100, the avionics databases 124 at the aircraft 102 may have a Flight Management System (FMS) Database including a Navigation Database (NDB), Performance Database that indicates the current state of the aircraft as well as performance or history data regarding parameters of the components being monitored by sensors on the aircraft, and an Airline Modifiable Information (AMI) Database. The avionics database 124 may include Electronic Flight Bag (EFB) Databases (whether mobile and coupled to the aircraft or part of the aircraft) such as Airport Charts, Operations Manuals, and Weather Information, a Maintenance Database, an Aircraft Health Monitoring System (AHMS) Database, an In-Flight Entertainment (IFE) Database, a Cabin Management System (CMS) Database and so forth. Additional databases may be included that are used for the alert safety systems mentioned below.

The root cause mismatch database 156 at the remote system 106 may store root cause mismatch tree structure templates and/or previously generated trees, where each tree, or part of a tree, in a total tree structure for an aircraft is directed to a different alert. The contextual information database 158 may list which context information or data (also referred to as basis date) is associated with a specific alert, where that contextual information may be mapped on the trees of the root cause mismatch database 156 as described below. The contextual information database 158 may hold the context information in a look-up table form that can be used by the root cause analysis unit 164. Otherwise, the contextual information database 158 provides the context information to list on a display on the aircraft when an alert with a mismatch is detected. Such contextual information may be the typical context categories that an aircrew would look up manually in response to a particular type of alert. By yet another option, a pilot may be given the option to display the look-up table from the context information database 158 as described in greater detail below.

Any of the databases mentioned herein may be updated on a periodic or iterative basis to ensure data relevancy and timeliness. In various implementations, any of these databases may be available online and accessible remotely by a suitable wireless communication system, such as the communication systems 122 and 150.

The onboard data sources 108 supply various types of data and/or measurements to the controller 112 so that the various avionics systems can generate relevant parameters, such as the state and condition of the aircraft including the flight and engine control settings and the actual states of the flight components and equipment, and engines on the aircraft. This may also include obtaining avionics value settings at each of the avionics systems, such as pilot input values (or default values) for various parameters such as speed, altitude, and so forth. Thus, the monitoring of avionic systems such as the autopilot, navigation, and/or flight management systems (FMS) to name a few examples may be monitoring real-time task execution, CPU loads, memory usage, data integrity, error logging, redundancy management, and so forth, in addition to providing the expected parameter values to be compared to actual parameter values generated from physical sensors on aircraft physical components. The onboard data sources may use an array of sensors 110 of various types to detect the actual condition or position of the components and equipment on the aircraft. The details and operation of the types of sensors are not needed for the understanding of the disclosed system and method.

In example implementations, the display device 128 is an electronic display capable of graphically displaying flight information or other data associated with operation of the aircraft 102. The display device 128 is communicatively coupled to, and controlled by, the display control unit 126 and/or processors 114. In this regard, the processors 114 and the display control unit 126 are cooperatively configured to display, render, or otherwise convey one or more graphical representations or images associated with operation of the aircraft 102 and relevant here, displaying alerts, root cause mismatches, and contextual information on the display device 128, as described in greater detail below. Generally, avionics display devices 128 visually convey a considerable amount of situational information for pilots. The displayed information is sourced from various databases, sensors, transponders, broadcasts, and FMS computations. The information is often organized in “information layers” (e.g., flight path information, Navigational Aids (NAVAID), airspace information, terrain information, weather information, traffic information, etc.). The various information layers are combined to provide a unified graphical display on the avionics display system.

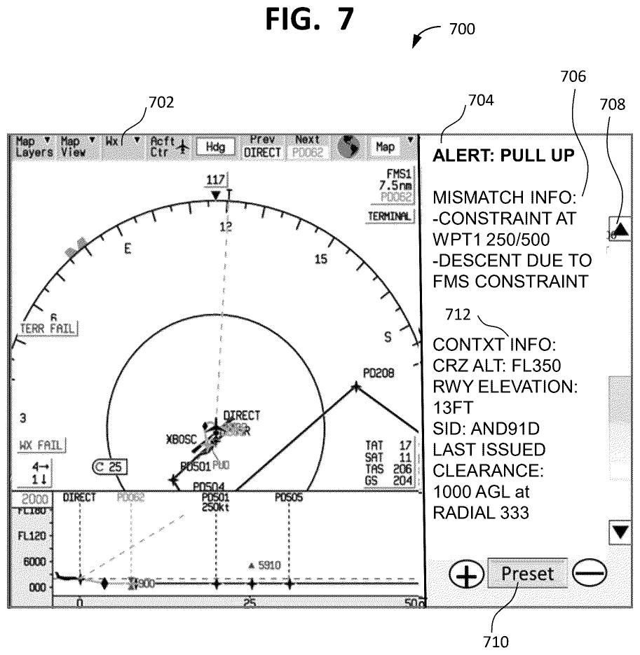

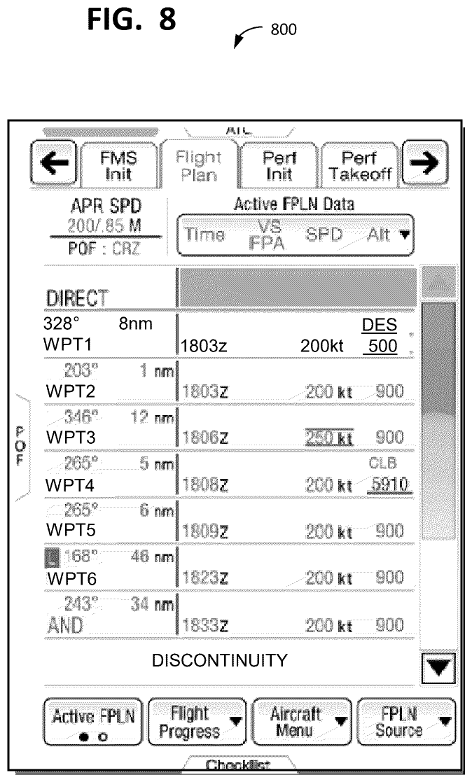

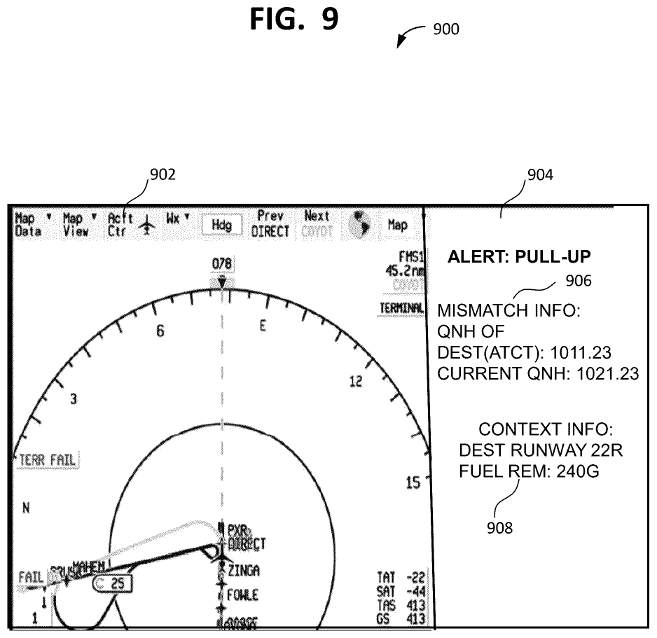

In various implementations, the display device 128 may be a multifunction control display unit (MCDU), cockpit display device (CDU), primary flight display (PFD), primary engine display (PED), multi-function display (MFD), navigation display (ND) which may include a horizontal situational display (HSD) or horizontal situation indicator (HIS), a vertical display that displays vertical trajectories or profiles (or data of vertical trajectories), or any other suitable multifunction monitor or display suitable for displaying various symbols and information described herein. The display device 128 may be configured to support multi-colored or monochrome imagery, and the display device 128 may have a liquid crystal display (LCD), a light emitting diode (LED) display, an organic light emitting diode (OLED) display, a heads-up display (HUD), a heads-down display (HDD), a plasma display, a projection display, a cathode ray tube (CRT) display, or the like. The example displays used for the example alert-related data herein are described on a PFD with an HSD above a vertical profile display (FIG. 7) or just an HSD (FIG. 9). Otherwise, root cause data may show on any display including an FMS flight planning page (FIG. 8) for reasons described below.

The user interfaces 132 (or user input interface) is a user interface coupled to the processors 114, and the user input interface 132 and the processors 114 are cooperatively configured to allow a user (e.g., a pilot, or crew member) to interact with the display device 128 and/or other elements of the system 100. Depending on the implementation, the user input interface 132 may be a keypad, touchpad, keyboard, mouse, touch panel (or touchscreen), joystick, yoke, steering wheel, knob, line select key, or another suitable device adapted to receive input from a user. These interface devices are on or part of display device 128, or are wired or wirelessly connected to the display device 128. This may include any controller or input device for controlling the motion of the aircraft in addition to any input device being used for root cause analysis described herein. In some implementations, the user input interface 132 is an audio input device, such as a microphone, audio transducer, audio sensor, or the like, accompanied with audio speech recognition and other software to input commands to an FMS, or other system or unit on the aircraft for example. In some implementations, the user input interface 132 is a tactile user input device capable of receiving free-form user input via a finger such as with touchpads or touch screens, stylus, pen, or the like. Specifically for any pilot inputs described herein, the display device 128 may display graphical user interfaces while an input interface 132 may include a touch screen directly on, or forming, a screen of the display device 128. By other approaches, the GUIs on the screen of the display device 128 may be a mouse cursor guided by a mouse or other type of controller forming the input interface 132.

The display control unit 126 has the hardware, firmware, processing logic and/or other components configured to control the display and/or rendering of one or more displays pertaining to operation of the aircraft 102 and/or avionics units or systems 117-120 described below, and displays on the display device 128 (e.g., synthetic vision displays, navigational maps, HSDs, vertical profile (trajectory) displays, and the like). Also, the display control unit 126 may access or include one or more avionics databases 124 suitably configured to support operations of the display control unit 126 as well as other example databases not shown such as a terrain database, an obstacle database, an air restriction database, a non-FRA navigational database, a geopolitical database, a terminal airspace database, a special use airspace database, or other information for rendering and/or displaying navigational maps and/or other content on the display device 128. In this regard, in addition to including a graphical representation of terrain, a navigational map displayed on the display device 128 may include graphical representations of navigational reference points (e.g., waypoints, navigational aids, distance measuring equipment (DMEs), very high frequency omnidirectional radio ranges (VORs), and the like), designated special use airspaces, obstacles, and the like overlying the terrain on the map. In one or more example implementations, the display control unit 126 accesses a synthetic vision terrain database that includes positional (e.g., latitude and longitude), altitudinal, and other attribute information (e.g., terrain type information, such as water, land area, or the like) for the terrain, obstacles, and other features including altitudes and altitude constraints to support rendering two-dimensional or three-dimensional perspective views of the terrain proximate the aircraft 102 for example.

The audio unit or panel 125 can have an intercom system providing internal communication between the pilot, other aircrew, avionics systems, and passengers. Relevant here, the avionics systems 120 can announce alerts to the aircrew through headset connections or loudspeakers in the cockpit. Otherwise, the audio panel or unit 125 may be used to manage audio communication and navigation systems, allowing the pilot to control various audio inputs. It facilitates radio communication management by enabling selection of radio transmitters and monitoring multiple frequencies simultaneously. Additionally, it allows pilots to listen to navigation aids like VOR, ADF, and ILS, adjust individual audio source volumes, mute or isolate specific audio channels, and access emergency features such as priority communication channels. The audio panel 125 also may enable listening to marker beacon signals, providing position information during an approach, and so forth.

In an implementation, the flight and engine controls 130 refer to the pilot controls in the cockpit used to control the aircraft components and equipment that move or position the aircraft and perform other tasks also controlled by the avionics systems 120. Thus, the flight control and engine controls 130 are monitored to detect whether the pilot has set the cockpit controls in an expected manner to operate the flight and engine components of the aircraft 102. This may include monitoring primary control devices such as a control yoke or stick (or steering wheel) and rudder pedals. Secondary flight controls monitored may include levers or switches for flaps, slats, and spoilers to modify lift and drag during different flight phases for example. For engine controls, throttles may be monitored that regulate engine power, adjust thrust in jet engines, or propeller's speed in piston engines. Other engine controls include mixture levers for fuel-air ratio adjustments in piston engines, propeller control levers for changing propeller pitch when present, and the fuel control panel for managing fuel flow, and so forth. Additional cockpit controls that may be monitored include the auto-throttle for automatically adjusting engine power to maintain a set speed, and various switches and knobs for managing systems like fuel pumps, ignition, de-icing, and so forth.

Still referring to FIG. 1, in one or more example implementations, the processors 114 on the aircraft 102 are coupled to the avionics systems 120 including an FMS, the communications systems 122, as well as other avionics systems 120 such as a navigation unit or system, and one or more additional avionics units to support navigation, flight planning, and other aircraft control functions, as well as to provide real-time data and/or information regarding the operational status of the aircraft 102 to the processors 114. It should be noted that the system 100 and/or aircraft 102 will likely include numerous avionics systems for obtaining and/or providing real-time flight-related information that may be displayed on the display device 128 or otherwise provided to a user (e.g., a pilot). For example, practical implementations of the aircraft system 100 and/or aircraft 102 will likely include one or more of the following avionics systems or units 120 suitably configured to support operation of the aircraft 102: a weather system, an air traffic management system, a radar system, a traffic avoidance system, an autopilot system, an autothrust system, a flight control system, hydraulics systems, pneumatics systems, environmental systems, electrical systems, engine systems, trim systems, lighting systems, crew alerting systems, electronic checklist systems, an electronic flight bag (EFB) and/or any other suitable avionics system.

The FMS may be configured to provide real-time navigational data and/or information regarding the operation of the aircraft 102. The FMS and similar systems receive input from various sources including an ATC, the pilots, sensors, the navigation databases mentioned, and so forth, and uses the inputs to compute flight plans including horizontal and vertical trajectories. The output showing a flight plan is then displayed or otherwise provided to the aircrew, and this may include flight information including waypoints, altitudes, airspace limitations, airspeed settings, and so forth. When the autopilot or auto thrust is to be used, the flight plan may be confirmed by the pilot before execution.

The avionic systems 120 also may include a performance unit or system that collects sensor data and places the data in a performance database for flight plan processing. The performance system may use the sensor data to convert measurements into a format or measurement units (kph for example) of performance parameters for use by the other units of the FMS. Such performance parameters may include aircraft state and condition (such as weight, fuel level, etc.), position (altitude and lateral location), attitude (roll, pitch, and yaw), airspeed, vertical speed, aircraft control settings such as for thrust, drag management, and so forth, fuel consumption, flight path data, and so on. The performance system can determine actual, current state, or past aircraft performance at a point in time or flight path location, or can compute estimated performance at a downpath location on a flight plan. Monitoring of the performance system provides data for root cause analysis described herein.

The avionic systems 120 also may have a separate weather system or unit that may have current weather conditions (or saved conditions at a certain time point) obtained from aircraft sensor data at sensor unit (not shown), wireless transmission from remote weather sources including the ATC or weather information servers, but also from the pilot or crew via FMS input pages displayed on input interface 132. Such information may include wind direction and speed, precipitation, humidity, air pressure, and so forth.

The avionic systems 120 may include an ADS-B unit that broadcasts and receives position, attitude, and direction transmitted between aircrafts, and may be used to determine air traffic constraints in addition to air traffic data, instructions, and/or altitude constraints received from the ATC or other sources.

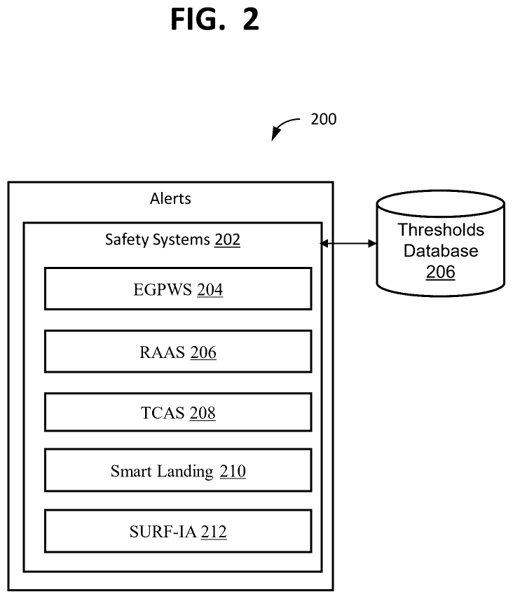

Other than the avionics systems 120, the memory 116 on the aircraft 102 may store any other program, unit, or system to operate the aircraft 102 and particularly for root cause analysis and display. Specifically referring to FIG. 2, an alert unit 200 is the same or similar to alert unit 118 (FIG. 1) and performs any of the functions that generate and display (or otherwise announce or inform) an alert to a pilot on the aircraft. This may include any system that receives sensor data or other data from internal sources on the aircraft and/or external sources, and determines when actual data values do not match expected data values or do not meet certain thresholds, or otherwise when conditions of a hazardous or undesired situation is detected. Such systems that may perform these comparison tasks may include safety systems 202 such as an enhanced ground proximity warning system (EGPWS) 204, runway awareness and advisory system (RAAS) 206, traffic collision avoidance system (TCAS) 208, smart landing system 210, surveillance and flight awareness integrated application (SURF-IA), airborne network traffic and hazardous environment monitoring (ANTHEM) system, and others. These systems enhance situational awareness for an aircraft by monitoring and analyzing network traffic and environmental hazards. Some of these systems provide real-time data on potential hazards, such as weather conditions or air traffic, helping pilots make more informed decisions and improve safety. These systems also integrate various data sources to offer a comprehensive view of the aircraft's surroundings and operational environment, aiming to reduce risks and optimize flight performance. For these purposes, the alert unit 200 also may have a threshold database 206, where alerts are issued when the difference between expected and actual data values do not meet a threshold or certain parameters reach a threshold. Other criteria may be used as well. Other systems such as a maintenance and weather systems also may provide alerts to a display in the cockpit of the aircraft 102. These systems may or may not be communicating with each other. Thus, each system may provide a separate alert, where a single event may trigger multiple alerts each being from a different system.

The memory 116 on the aircraft 102 also may hold an RC data collect (or collection) unit 117 to collect the data to be used to analyze an alert. The RC data collection unit 117 unit may be a stand-alone unit or may be part of any of the systems that generate an alert. The data collected may be both expected data values (such as altitude constraints) and actual data values indicating a state of the aircraft 102 at a time of an alert. The collected data then may be used by an RC analysis unit onboard when such as provided, but in the present example, the RC data collection unit 117 (or another unit onboard the aircraft 102) may initiate transmission of the collected data along with an identification of the alert to the remote system 106 where the root cause analysis can be performed remotely from the aircraft 102. The collected data that is used by the aircraft systems to detect or generate an alert may be referred to as basis data, and this may include data collected to eliminate the reason for an alert that is part of the contextual data described herein.

An RC message unit 119 also may be provided on the aircraft 102 in this example to receive message data from the remote system 106, and that is either data to be used to generate one or more root cause mismatch messages and/or contextual information messages to display to a pilot. The received data may or may not already be in the form (or text) of a message. Thus, the RC message unit 119 may generate and display messages by using message data received from the remote system 106.

The remote system 106 has the root cause (RC) analysis unit 164 to determine root cause mismatches between expected and actual avionics values used to operate the aircraft and/or indicate avionic parameters that cause an alert. Once a root cause mismatch is detected, the contextual information unit 166 collects the context information that should be displayed to the pilot at the aircraft and that corresponds to a particular alert, thereby displaying the context a pilot would have checked manually without the present methods and systems. The RC analysis unit 164 and the contextual information unit 166 are explained in greater detail below.

It will be appreciated that FIG. 1 is a simplified representation of the aircraft system 100 for purposes of explanation and ease of description, and FIG. 1 is not intended to limit the application or scope of the subject matter described herein in any way. It should be appreciated that although FIG. 1 shows the display device 128, the user input interface 132, and the processors 114 as being located onboard the aircraft 102 (e.g., in the cockpit), in practice, one or more of the display device 128, the user input interface 132, and/or the processors 114 may be located outside the aircraft 102 (e.g., on the ground as part of an air traffic control center or another command center, or on a simulator) and communicatively coupled to the remaining elements of the aircraft system 100 (e.g., via a data link and/or communications system 122). Thus, by one form, the term onboard generally refers to at least those main tasks performed by each unit, system, or component of system 100 that must be performed onboard the aircraft, although any of these units may have tasks performed remotely via wireless communication off-board as mentioned. Thus, the on-board portion of these components, systems, or units may communicate data to other components, units, or systems onboard or provide data to the pilot, while the processing of the data such as computations or operation of algorithms may be performed remotely from the aircraft. By one form, at least the display device 128, input interfaces 132, and processors 142 are onboard. Many variations are contemplated.

In some implementations, the units, components, or systems of system 100 may be at least partially operated from remote devices whether the device is on-board or off-board. For example, the display device 128, the user input interface 132, and/or the processors 114 may be implemented as an electronic flight bag (EFB) that is separate from the aircraft 102 but capable of being communicatively coupled to the other elements of the aircraft system 100 when onboard the aircraft 102, and whether wirelessly or by wire. Similarly, in some implementations, the data storage element or memory 116 may be located outside the aircraft 102 and communicatively coupled to the processors 114 via a data link and/or communications unit 122. Furthermore, practical implementations of the aircraft system 100 and/or aircraft 102 will include numerous other devices and components for providing additional functions and features, as will be appreciated in the art. In this regard, it will be appreciated that although FIG. 1 shows a single display device 128, in practice, additional display devices may be present onboard the aircraft 102. Additionally, it should be noted that in other implementations, features and/or functionality of processors 114 described herein can be implemented by or otherwise integrated with the features and/or functionality provided by the display control unit 126 or the FMS, or vice versa. In other words, some implementations may integrate the processors 114 with the display control unit 126 or the FMS. Thus, the processors 114 may be a component of the display control unit 126 and/or the FMS or other avionics system 120.

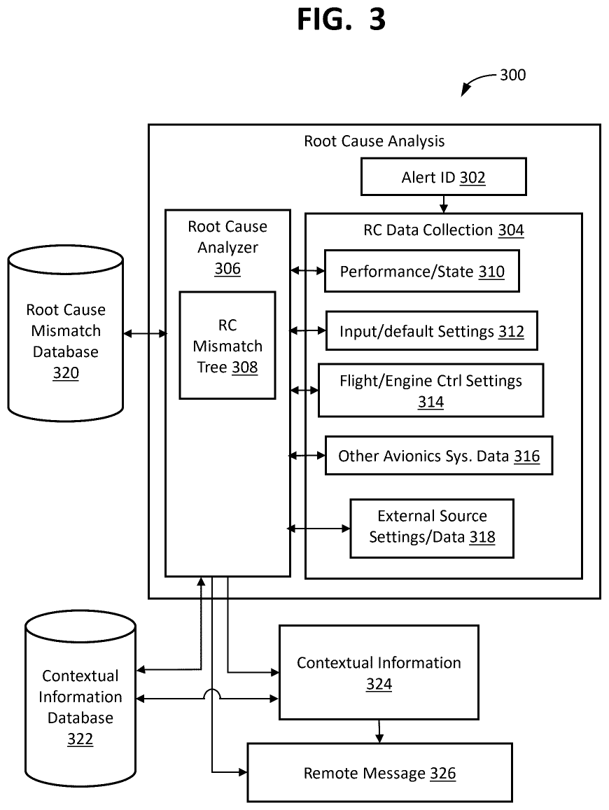

Referring to FIG. 3, a root cause (RC) analysis unit 300 is located at a remote system, such as remote system 106, and is the same or similar to the RC analysis unit 164 at the remote system 106 (FIG. 1). The RC analysis unit 300 has, or is communicatively coupled with, a contextual information unit 324, which is the same or similar to the contextual information unit 166 at the remote system 106 (FIG. 1). The root cause analysis unit 300 has an alert ID unit 302, a remote RC data collection unit 304, and a root cause analyzer 306. The alert ID unit 302 receives a transmission via the communications unit 150 of the identification of an alert and the data used to determine the alert as collected by the RC data collect unit 117 at the aircraft 102. The alert ID may include the name or code for the type of alert, such as “Pull-Up”, as well as any of the parameter data or other settings, sensed values, avionics systems values (all generally referred to as the basis data which may include the contextual information data) determined to be associated with determining the alert. By one example, this may include an altitude constraint, an altitude target value input by a pilot, an ambient pressure, and so forth just to name a few random examples. More specifically, the RC data collection unit 304 receives the transmitted basis data such as performance data 310 that indicates a state of the aircraft 102, and input and/or default settings 312 data that indicates avionics systems' values input by the pilot or that are default values when no input is received. The basis data also may include flight and/or engine control settings data from the monitoring of the flight/engine controls 130 (FIG. 1) on the aircraft 102, and any other avionics systems data 316 that is relevant to the alert ID. Otherwise, data may be obtained directly or indirectly via the aircraft 102 and from external sources 318 external to the aircraft 102, such as from weather systems or servers (or agencies or entities), ATCs, and so forth that may provide basis data relevant to the alert ID but that may or may not have been known by the systems on the aircraft 102. Thus, the root cause analyzer 306 may have more or different basis data than that used on the aircraft 102 to trigger an alert.

The root cause analyzer 306 receives all of the alert IDs and the basis data, and operates a root cause mismatch tree unit 308 for a specific type of alert and by using the root cause mismatch database 156 (here 320) to obtain tree templates and other data. The RC analyzer 306 then may use look-up tables or other database structures to determine which contextual information of basis data or parameters should be used to populate the nodes of the trees and obtained from the contextual information database 322 (or 158) or other sources. The basis data values received from the aircraft then may be placed on the tree (or used at the individual nodes on the tree) to determine if a root cause mismatch exists at any of the tree nodes. When a current node with a mismatch is connected to one or more higher branch levels, then connected higher branch nodes also are tested as well, and this is repeated for each node to determine the most detailed root cause mismatch. Once a final root cause mismatch is detected at a highest node of the mismatches, the mismatched data (such as an input altitude value and a conflicting altitude constraint for example) is provided to a remote message unit 326 that generates a message or message data that indicates or explains the mismatch data. The message or message data is then transmitted back to the aircraft to display the message indicating the mismatch data.

Optionally, a contextual information unit 324 may add contextual information being indications of the basis data that show contextual information (avionics systems values or information, sensed values or information, values or information form external sources, and so forth) that contributed to the decision or determination of a mismatch. This may include providing contextual information that did not cause a mismatch but still may be shown to a pilot to clearly and quickly dismiss a potential reason of the mismatch. The list of which contextual information to display for an alert may be obtained from the contextual information database 322. The contextual information may be transmitted with the message or message data or may be transmitted separately, if being provided at all. The details are provided with process 400 below.

Thus, any of the RC units 164 and 166, or other programs 162, at the remote system 106 then may transmit mismatch message data and contextual information message data (when also being provided) back to the aircraft to display the messages to the pilot using the communications system 150. Memory 160 at the remote system 106 also may include any other avionics system, unit, or module for communicating data between the remote system 106 and the aircraft 102, and/or analyzing data from the aircraft 102 for other reasons.

By another alternative, it will be understood that the root cause analysis unit 300 may be located on the aircraft 102 instead of being remote, when the processors 114, memory 116, and other units on the aircraft have the capacity to handle the processing, storage, communication bandwidth consumption, and so forth to be used for onboard root cause analysis.

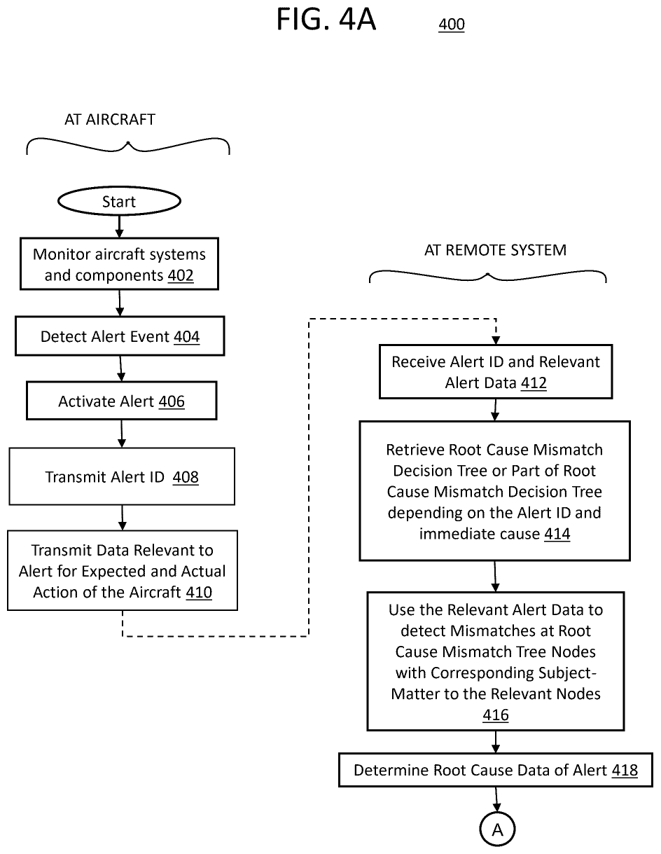

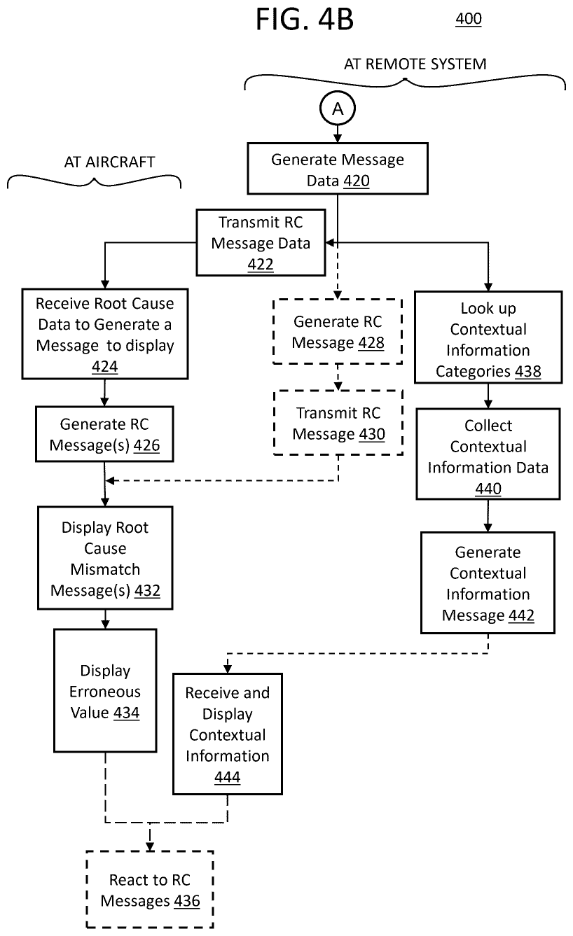

Referring now to FIGS. 4A-4B, an example process 400 for determining and displaying a root cause of an alert is described according to at least one of the implementations herein. The process 400 includes operations 402 to 436, generally numbered evenly. Systems, device, modules, units, avionics display images, and root cause mismatch trees of any of FIGS. 1-3 and 5-9 may be referred to for the description of process 400, where relevant.

Process 400 shows the continuing example setup where an alert is initiated on an aircraft, such as aircraft 102, and data is transmitted to a remote system, such as remote system 106, to perform root casus analysis that generates root cause mismatch data indicating a root cause of the alert. Data of the detected mismatch, and optionally contextual information data, is then transmitted back to the aircraft for display to the aircrew so that the aircrew can react appropriately to the alert and root cause mismatch, if detected, of the alert. Process 400 has operations designated as at aircraft or at remote system accordingly. Other alternatives, however, can be used when the aircraft has a sufficient amount of computing, memory, and data transmission capacity to perform the root cause analysis onboard the aircraft instead.

Process 400 may include “monitor aircraft systems and components” 402, and as described above, the onboard data sources 108 and the sensors 110 on an aircraft 102 may be monitoring many different components of the aircraft (such as parts, equipment, and systems including avionics system software) as mentioned in detail above. To mention a few random examples, the sensors may be monitoring airspeed, altitude, pitch angle, roll rate, vertical speed, engine RPM, etc. to indicate the current (or other set time instant) state of the aircraft. This monitoring operation also may include tracking input avionics values received from the aircrew and default values when no input is received and still must be used by the avionics systems, such as an altitude for flight planning by the FMS for example. By one form, this operation may cover any monitoring of aircraft components, the environment, and/or aircrew actions as described above that can contribute to triggering an alert.

Process 400 may include “detect alert event” 404, and by the avionics systems, and particularly including the example safety systems of the alerts unit 200 (FIG. 2) that may monitor for any technical failures, procedural issues, and human errors as described above. Thus, this includes any alert triggering analysis, whether a part malfunction, a procedural error such as a checklist going unfinished, a pilot avionics system input value or control setting, and so forth. Such systems use their own algorithms, logic, fault trees, neural networks, and so forth to analyze basis data (or parameters) of any type, and determine if the basis data indicates an alert event by meeting alert criteria, such as parameter value thresholds or other techniques. Thus, one example may be an actual current aircraft altitude going below an above ground level (AGL) constraint as an immediate cause of the alert.

Process 400 may include “activate alert” 406, where such an alert may be announced such as an alert that may be “PULL UP” in the AGL example. The alert may be shown on one or more cockpit displays, or may be audibly announced over cockpit speakers (whether loudspeakers, headset speakers, or other speakers) or both to announce the alert whether simultaneously or at different times. Avionics display images 700 (FIG. 7) and 900 (FIG. 9) both show a display of this alert as “ALERT: PULL UP” shown in bold here but may have many different visual features to emphasize the alert whether font type, font size, color, and so forth.

Process 400 may include “transmit alert ID” 408, and from the aircraft to the remote system. By one example form, once a trigger to announce an alert is made, this action triggers transmission of the alert and supporting basis data to a location that will perform the root cause analysis. Thus, the exact timing of the announcement of the alert itself is not limiting. In other words, the transmission of the alert and basis data may occur due to an alert that will be announced, is currently being announced, or has already been announced. Of course, it is desirable to have the root cause processing complete as soon as possible when time is of the essence and a pilot needs time to respond to the alert appropriately. The alert ID may be the name of the alert or an index code or other code that corresponds to the alert and can be decoded at the remote system.

Process 400 may include “transmit data relevant to alert for expected and actual action of the aircraft” 410 and from the aircraft to the remote system. Here, the identification of any basis data (parameters, avionics systems values, pilot input values or control settings, and so forth) that were used to trigger an alert on the aircraft or are considered contextual information data that may be a reason of the alert. By some random examples, this may include a mode control panel (MCP) altitude setting, incorrect QNH setting, an ATC clearance, a low angle of attack, incorrect thrust lever positions, FMC altitude constraint, and so on. This basis data may be collected and sent to the remote system 106 by RC data collect unit 117 via the communications system 122 for example. The alert data (the alert ID and basis data) may be transmitted to a cloud location by one example, and may be in the format of metadata transmitted over 5G networks, SATCOM, or other networks mentioned above.

At the remote system, process 400 may include “receive alert ID and relevant alert data” 412. This operation involves receiving the alert data transmitted from the aircraft by SATCOM or other communications system as mentioned above. Other alternative arrangements may be used instead. Also, while the process 400 discusses a single remote system, as mentioned above, a single gateway or edge remote system may first receive data from the aircraft but then spread the data and/or use multiple remote systems to perform the analysis mentioned herein.

In this operation, while the remote system receives the identification of the alert and the corresponding or accompanying basis data from the aircraft, in addition, this operation may include the remote system receiving relevant alert data from sources external to the aircraft and either directly from the external source or via the aircraft. Thus, the aircraft's avionics systems may or may not have information or data from the external sources received at the remote system. This may include information from an ATC, Automatic Terminal Information Service (ATIS), weather service, and so forth. Thus, as one example, atmospheric pressure value QNH may be received from an ATIS broadcast rather than, or in addition to, the aircraft. This operation may include receiving continuous external source transmissions whether or not an alert is received and to be analyzed. In other alternatives, the remote system may operate a communications system 150 to monitor receipt of data or information only when needed for a specific alert root cause analysis, and this may include monitoring all external sources providing a transmission. Otherwise, the remote system may monitor external sources only for transmissions relevant for a particular alert. Thus, by one example, a remote system may only monitor a specific ATIS to learn of an atmospheric pressure QNH value when altitude is an issue related to an alert root cause to be analyzed.

Process 400 may include “retrieve root cause mismatch tree or part of root cause mismatch tree depending on the alert ID and immediate cause” 414. Thus, by one example algorithm, a root cause mismatch tree is used to determine whether a mismatch exists that indicates a root cause of an alert. This first includes identifying the type of alert from among many possible alerts as described above. Here, after the received alert ID is read, a tree template for a root cause mismatch tree (or part of an entire root cause mismatch aircraft tree) is retrieved from the root cause mismatch database 320 that may hold a library of different root cause mismatch trees, where each or individual trees may be provided for each or individual types of alerts. The tree templates each may already provide nodes for the relevant basis parameters or data of each alert type. The nodes may each correspond to a different type of contextual information associated with an alert type, and this correspondence also may be listed in the contextual information database 322. In other forms, the tree templates are provided in a basic form or structure only with main basis parameter nodes. In this case, the RC mismatch tree unit 308 may look up the specific alert in the contextual information database 322 to determine which contextual information (and which nodes) need to be added to a root cause mismatch tree to complete the tree. More details of the look-up tables of the contextual information database 322 are provided below.

Process 400 may include “use the relevant alert data to detect mismatches at root cause mismatch tree nodes with corresponding subject-matter to the relevant nodes” 416. Here, the RC mismatch tree unit 308 may populate the tree templates with the avionics basis data values including parameter values or other relevant information (such as binary yes or no answers to questions such as whether the autopilot was activated, a certain state of the aircraft occurred, or a climate condition was present for example), and received from the aircraft or other external source, and now consistent with the contextual information correspondences or associations from the contextual information database 322.

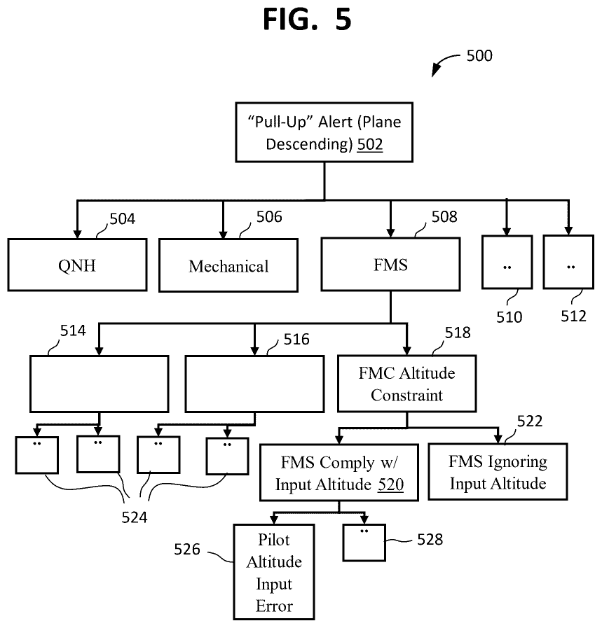

Referring to FIG. 5, an example root cause mismatch tree 500 is a top-down, hierarchical structure used to systematically analyze the causes of system failures. A ‘higher’ branch level here, however, refers to farther away from the root node (or lower in the FIG. 5). It begins with a main root node or top event node 502 that represents the alert and in turn a main intermediate cause (or overall system failure, fault, condition, event, or environment) that is being analyzed. The top event node 502 branches out into child nodes or intermediate event nodes (or just intermediate events) 504 to 520 numbered evenly, each representing a root cause mismatch of avionics values, settings, or information of the same or different subsystems or sub-components that can contribute to the top event root cause. These intermediate nodes 504 to 520 can further branch out into more specific root causes or root cause mismatches, creating a tree structure and terminating at basic events (or leaf nodes) 522, 524, 526, and 528. The basic events represent the most specific root causes of failure or other alert events, such as individual component failures, environmental conditions, or human errors (or more precisely any aircrew actions as described above). Basic events are the end points in the root cause mismatch tree. The logical operators connecting the gates may be AND or OR gates, or other operators. An AND gate implies that all conditions or failures (or mismatches) in the child nodes must occur for the parent node to have a mismatch or fail, while an OR gate indicates that any one of the child node mismatches can cause the parent node to have a mismatch. This hierarchical breakdown continues until a basic event is reached, and which may be on varying branch levels of the tree 500. By analyzing the root cause mismatch tree from the root down to the leaf nodes, you can trace the sequence of alert mismatches relating to failures or errors (the conditions of the immediate cause) that lead to the triggering of the alert. This structured approach helps in identifying the root cause mismatches and understanding the interactions between different subsystems and components, enabling more targeted and effective mitigation strategies. Line replaceable units (LRUs) equipment and/or shop replaceable units (SRUs) equipment related to the alert can be traced through the tree, and the exact branch causing the alert can be determined.

In the example of tree 500, the alert is “PULL UP” indicating an immediate cause that being the plane descending toward, at, or being below an altitude constraint. In this example, more immediate cause nodes are provided on a first level branch and include QNH 504, mechanical 506, FMS 508, and many others. Each of these nodes may have criteria or a test to determine whether an intermediate or root cause mismatch of the alert is indicated, such as a comparison of expected and actual avionics values or comparison of an avionics value to parameter thresholds, and so forth. The next higher level branch may have node criteria tests for more detailed alert causes that is, or closer to, a root cause of the alert, and so on until basic event (leaf) nodes are reached with the most detailed root cause mismatches.

Process 400 may include “determine root cause data of alert” 418. In the present case the FMS node 508 has branches 514, 516, and 518, where node 518 tests an FMC altitude constraint. If the FMS itself is ignoring an input (including a default) altitude, a branch node 522 is then tested, but if the FMS is complying with an input (or default) altitude at 520, then a test is performed to determine if the input altitude conflicts with another altitude to result in a mismatch. In this example, say an input altitude from a pilot (or a default altitude and the pilot did not enter an altitude value) conflicts with an altitude constraint, such as a minimum AGL elevation at node 526, then this is the root cause mismatch causing the pull up alert and to be reported back to the aircrew to make a correction on the aircraft. Other possible root cause mismatches at nodes 524 and 528 are eliminated by the tree analysis.

Thus, some nodes of the tree indicate operation of at least one comparison between values (often expected and actual values associated with the aircraft and/or avionics systems of the aircraft). There may be many value comparisons of different combinations of value comparisons at a single node. Likewise, the node operations may include comparing a single value to at least one parameter threshold, but may be comparisons of a single value to many thresholds, or may be many different values each compared to at least one threshold still at a single node. Also as mentioned, the node computations may be or have one or more simple binary (or other) determinations to determine if a system is on (or activated) or off (or deactivated), and any other determinations regarding basis data information that may be part of an algorithm at any of the nodes. It will be understood that an algorithm at a single tree node may be any combination of these operations, and a determination of a single type of mismatch may include these operations of at least one node and may include operations of multiple tree nodes. Thus, the root cause mismatch tree may be operated with many variations and combinations of these operations mentioned here.

It will be appreciated that one or more neural networks may be used to operate the root cause mismatch trees and may be a recurrent neural network (RNN) model by one example, but may have many different architectures as desired. The neural network may be trained on historical data and maintenance data of the aircraft or many aircraft over long periods of time (such as years) to output accurate alert root cause mismatch predictions. Thus, the neural network considers past incidents and maintenance issues for the particular aircraft, and by one option, may be trained based on a fleet of aircraft.

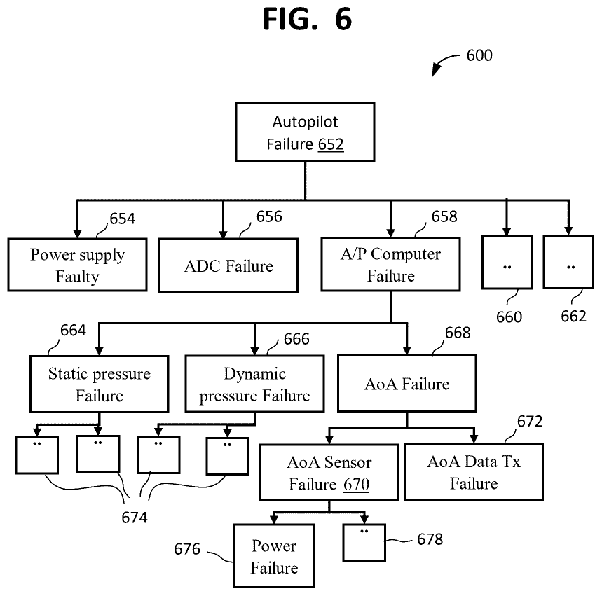

Referring to FIG. 6 for another example root cause mismatch tree, the top event 652 is an autopilot failure with an alert: “A/P NOT AVAILABLE” as one example. As with root cause mismatch tree 500, root cause mismatch tree 600 also has a comparison performed at each node to determine whether an alert-related mismatch exists. In this example case, first level branches of direct possible intermediate root causes of power supply faulty 654, air data computer (ADC) failure 656, autopilot (A/P) computer failure 658, and others numbered as 660 and 662. As shown, the tree 600 continues from the A/P computer failure node 658 indicating this was a higher level root cause mismatch of the failure or fault. Branching from the A/P computer failure node 658, second level possible intermediate events include static pressure failure 664, dynamic pressure failure 666, and angle of attack (AoA) failure 668. The root cause mismatch tree 600 shows possible basic events 674 branching from the static pressure failure node 664 and dynamic pressure failure node 666, but end there indicating the root cause mismatch is not in this technology area. Instead, the AoA failure node 658 has third level branches of AoA sensor failure 670 and AoA data transmission (Tx) failure 672, the latter ending as a basic event. The basic event root cause mismatch of the alert, however, is a fifth level branch from the AoA sensor failure node 670 and indicates a power failure (or power failure basic event or leaf node) 676. It will be understood that the root cause mismatch tree may have many different structures, and a root cause mismatch tree for an entire aircraft may be extremely large. Even transmitting a small part of an entire root cause mismatch tree, as represented by root cause mismatch tree 600, may be too much data to use and/or transmit efficiently on the aircraft.

Once a mismatch is detected, process 400 may include “generate message data” 420. This operation may include determining codes and/or text that indicates the type of mismatch and includes the parameter or basis values that are mismatched. At this point, the root cause analyzer 306 may just transmit 422 the message data to have the RC message unit 119 receive 424 the message data at the aircraft 102 and generate 426 the text and language of the message to be displayed to the aircrew. Otherwise, the root cause analyzer 306 may have the message data converted or generated 428 into the actual message to be displayed, and then have the message transmitted 430.

In either case, process 400 may include “display root cause mismatch message” 432. This involves having the RC message unit 119 display the message on a display device 128 on the aircraft. Alternatively or additionally, the message may be audibly announced instead or as well such as by audio unit 125. By one form, an alert window may pop up on one of the avionics display screens or displays, whether or not the window shares a screen with another avionics display screen such as a PFD, HSD, vertical profile image, FMS page, and so forth. By some forms, the alert window may be shown with an avionics display that is most relevant to the type of alert. Thus, an alert regarding altitude may show with a vertical profile or trajectory display. By other options, this is not the case, and the alert window may be shown on whatever avionics display is currently being displayed in a cockpit or at a certain position in the cockpit, such as a central most display or display in the center of a pilot's or co-pilot's instrument panel. Otherwise, the alert window may be shown on its own screen without other avionics displays. Many variations are contemplated.

Referring to FIG. 7 for one example, an avionics display 700 may be a PFD that has a horizontal or lateral situation display (HSD) or image 702 above a vertical profile and both next to an alert window 704. It will be understood that the HSD and vertical profile images 702 are provided merely to provide a general sense of the type of avionics display that may be used and particular text on the HSD need not be clear to convey an understanding of the type of avionics display that can be used. The text and details of the HSD and vertical display are not needed for understanding of the systems and methods described herein. This is true for each of the avionics displays of FIGS. 8 and 9 as well.

In this example, the alert of “PULL UP” is indicated, and a mismatch message 706 states “mismatch info:”, “constraint at WPT1 250/500” and “descent due to FMS constraint.” This refers to a waypoint 1 along a flight plan that has a speed/altitude input of 250/500 in a known format for an aircraft. The 500 refers to a constraint to move the plane to an altitude of 500 feet, and where this has been programmed into the FMS (whether by pilot entry or a default setting). Assume this is during a climb stage after takeoff and the aircraft is already above the 500 feet and now starts descending. By displaying this mismatch, a pilot may realize that the entry should have been 250/500A, which refers to “500 ft or above.” When the autopilot is engaged, the aircraft is trying to descend towards the WPT1 of 500 ft until the constraint is met. The alert window 704 also may have a scroll control 708 and a preset plus/minus activator 710 to change the values on the display screen, and here may be used to change the values directly in the mismatch message when such feature is desirable. The text of the message can have many different formats including plain English, certain abbreviations and codes known to aircraft crews, and so forth. Thus, the pilot may react 436 to the mismatch or RC message right away.

Referring to FIG. 8 for another alternative, process 400 may include “display erroneous value” 434, and displayed on the screen where the value was input into the FMS in the first place and in addition to displaying the alert window 704 (FIG. 7). Thus, in one example an FMS display 800 shows an order of legs for a flight plan with waypoints WFT1 to WPT6. The first leg to WFT1 is the same WFT1 mentioned on alert window 704 (FIG. 7). Here, WFT1 shows where the altitude ‘500’ was entered. It also shows the aircraft is currently in a descent to that altitude. This confirms the details of the mismatch on the alert window 704. The display 800 may use visual features to emphasize the relevant altitude ‘500’ associated with the window alert 704, and this may include highlighting or font colors, font style or size, bold, italic, underline, or any other emphasizing features that better bring the altitude value to the pilot's attention on the FMS flight plan page 800.

Returning to operation 438 at the remote system 106, and after the message data is generated (420), process 400 may optionally include “look up contextual information categories” 438, where the types of contextual information associated with an alert are looked up in order to display the contextual information on the displays on the aircraft, and by one example, in the alert window being displayed. This may happen automatically or may be triggered upon a request from the pilot to display this information. The categories may be collected from the contextual information database 322, and may include the alerts and contextual information in look-up tables such as table 1 below as one possible example.

TABLE 1

| Alert | Immediate Cause | Contextual Information |
|---|---|---|
| PULL UP | LOW ALTITUDE | Incorrect Setting of Altitude |
| TOO LOW | FLYING | Flying incorrect Runway |
| TERRAIN | | Incorrect QNH Setting |
| DON'T SINK | | ATC clearance |
| | | Low climb rate |
| | | Incorrect thrust lever positions |
| | | FMC altitude constraint |
| CAUTION WIND | WIND DATA | ATC Clearance |
| SHEAR AHEAD | PARAMETERS | Weather Radar Data |
| | NOT | |
| | CONSIDERED | |
| | FOR FPLN | |

Thus, the pilot may be able to request a display of the data in a table from the contextual information database 322 relevant to a current alert. The data may or may not be displayed in the format of the table. Once the categories, or classes, or types of contextual information associated with an alert are determined for display, process 400 may include “collect contextual information data” 440, where the data values or other information for each contextual information type is collected and may be stored in a memory by the root cause analyzer unit 306, the RC data collection unit 304, or other unit.

Process 400 may include “generate contextual information message” 442, and as with the root cause mismatch data, may either generate data the aircraft can use to generate a contextual information message itself, or the remote message unit 326 may generate the contextual information message, and in a format as explained with the mismatch message. The contextual information message (or message data) is then transmitted to the aircraft as explained above with the mismatch message.

Process 400 may include “receive and display contextual information message” 444, and continuing with the example of alert window 704, a contextual message 712 is displayed and here shows “CONTXT INFO:”, “CRZ ALT: FL350” (cruise altitude flight level 35,000 ft), “RWY ELEVATION: 13 FT” (runway elevation), “SID: AND91D” (standard instrument departure: airport departure procedure 91D), and “CLEARANCE” 1000 AGL at RADIAL 333”, which is the last instruction from an ATC to fly to 1000 ft above grade level at heading 333. The 1000 ft instruction also clearly shows the mismatch with the 500 ft FMS setting. With such a clear layout of the mismatch, a pilot can easily see how to correct the descent of the aircraft. It should be understood that as an alternative, the contextual information of the 1000 ft clearance could instead, or additionally, be shown in the mismatch information since it is so clearly relevant to the alert.

Referring to FIG. 9 for another example to show a different type of example alert, an avionics display 900 on an aircraft may show an HSD 902 and an alert window 904. In this case, the alert is still “PULL-UP”, but now the mismatch was found to be a QNH value that is an altimeters' barometric pressure setting (or just altimeter setting), which is used to determine a current altitude of the aircraft. The mismatch information 906 states “QNH OF DEST (ATCT): 1011.23” (indicating the pressure from the air traffic control tower at a destination airport) and “CURRENT QNH: 1021.23”. The contextual information 908 states “DEST RUNWAY 22R” (destination runway 22R which indicates the position of the runway) and “FUEL REM: 240G” (fuel remaining 240 gallons), which are two other possible basis data categories a pilot may check in this circumstance.

In this case, the root cause analyzer 306 can determine the standard pressure setting of 1013 hPa was being used by the aircraft, while a local barometric pressure of 1007 hPa was being broadcast as an ATIS broadcast. This broadcast may have been received by the root cause analyzer 306 at the remote system but may have been missed at the aircraft. Thus, a flight crew may descend the aircraft to a minimum descent altitude of 500 ft as indicated by the altimeters on the aircraft, while due to the actual barometric pressure, the aircraft actually descends to a height significantly below 500 ft. The root cause analyzer 306 can detect this mismatch of QNH pressure values by comparing the values and the initiating the display on the aircraft of the mismatch information so the crew can understand the mismatch that caused the alert.

Process 400 may include “react to RC messages” 436, where the pilot viewing the mismatch information, and the contextual information when present, may quickly react by inputting a new altitude (or pressure) values into the FMS and/or other avionics systems as well as turning off the autopilot and pulling up on the control stick to guide the aircraft back upward. Many variations are available.

It will be appreciated that the various illustrative logical blocks, units, modules, circuits, and algorithm operations described in connection with the implementations disclosed herein may be implemented as electronic hardware, firmware, computer software, or any combination of these. Some of the implementations and implementations are described above in terms of functional and/or logical block components (or modules or units) and various processing operations. However, it should be appreciated that such block components (or modules or units) may be realized by any number of hardware, software, and/or firmware components configured to perform the specified functions. To clearly illustrate this interchangeability of hardware and software, various illustrative components, blocks, modules, circuits, and operations have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention. For example, an implementation of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that implementations described herein are merely exemplary implementations.

The subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can perform the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an implementation of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” or “units” in order to particularly emphasize their implementation independence. For example, functionality referred to herein as a module or unit may be implemented wholly, or partially, as a hardware circuit comprising custom VLSI circuits or gate arrays, off-the-shelf semiconductors such as logic chips, transistors, or other discrete components as described above. A module may also be implemented in programmable hardware devices such as field programmable gate arrays, programmable array logic, programmable logic devices, or the like. Modules or units may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process operations must be performed in a temporal or logical order according to such sequence unless it is specifically defined by the language of the claim. The process operations may be interchanged in any order without departing from the scope of the invention as long as such an interchange does not contradict the claim language and is not logically nonsensical.

Furthermore, the foregoing description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. For example, two elements may be coupled to each other physically, electronically, logically, or in any other manner, through one or more additional elements. Thus, although the drawings may depict one exemplary arrangement of elements directly connected to one another, additional intervening elements, devices, features, or components may be present in an implementation of the depicted subject matter. In addition, certain terminology may also be used herein for the purpose of reference only, and thus are not intended to be limiting.

While at least one exemplary implementation has been presented in the foregoing detailed description of the invention, it should be appreciated that a vast number of variations exist. It should also be appreciated that the exemplary implementation or exemplary implementations are only examples, and are not intended to limit the scope, applicability, or configuration of the invention in any way. Rather, the foregoing detailed description will provide those skilled in the art with a convenient road map for implementing an exemplary implementation of the invention. It being understood that various changes may be made in the function and arrangement of elements described in an exemplary implementation without departing from the scope of the invention as set forth in the appended claims.

What is claimed is:

1. A method comprising;
receiving, by at least one processor, an indication of an alert to announce on a vehicle to inform a user on the vehicle of an undesirable event associated with the vehicle;
automatically determining, by at least one processor, an immediate cause of the alert;
automatically determining, by at least one processor, root cause mismatch data that indicates conditions that formed the immediate cause of the alert, wherein the mismatch data comprises a mismatch of vehicle data between data related to an expected action or inaction of the vehicle and data related to an actual action or inaction of the vehicle; and
providing the mismatch data to automatically generate a message indicating the mismatch and to announce the message on the vehicle.

2. The method of claim 1, comprising collecting contextual information data from one or more avionics systems and relevant to the mismatch data; and providing the contextual information data to generate contextual information to be announced on the vehicle.

3. The method of claim 1, wherein the root cause mismatch data includes a data entry input to an avionics system and from a pilot on an aircraft.

4. The method of claim 1, wherein the root cause mismatch data includes an aircraft control setting set by a pilot.

5. The method of claim 1, comprising receiving the indication and performing the determining of the immediate cause and root cause mismatch data at a location remote from the vehicle; and transmitting at least a version of the mismatch data from the location and back to the vehicle to inform the user of the root cause mismatch data.

6. The method of claim 1, comprising displaying the alert, the root cause mismatch data in a cockpit of an aircraft.

7. The method of claim 6, wherein the alert and the root cause mismatch data are displayed on the same display screen at the same time.

8. The method of claim 6, comprising displaying contextual information associated with the alert.

9. The method of claim 1, comprising using a mismatch tree to determine the root cause mismatch.

10. The method of claim 1, comprising using a database of contextual information to determine which avionics data parameters are to be considered to determine a root cause mismatch of the alert, wherein each different type of alert has a different set of contextual information to consider.

11. A vehicle, comprising:
a display device to display alerts; and
processor circuitry forming at least one processor arranged to operate by:
generating an indication of an alert of an undesirable event associated with the vehicle;
announcing the alert on the display device;
automatically determining an immediate cause of the alert;
automatically determining root cause mismatch data that indicates conditions that formed the immediate cause of the alert, wherein the mismatch data comprises a mismatch of vehicle data between data related to an expected action or inaction of the aircraft and data related to an actual action or inaction of the vehicle; and
automatically announcing a message indicating the mismatch and on the display device of the vehicle.

12. The vehicle of claim 11, wherein the at least one processor is arranged to operate by:
transmitting the indication of the alert and basis data used to determine the conditions, wherein the transmission is performed to have the automatically determining of the root cause mismatch data performed remotely from the vehicle; and
receiving either the message or message data to be used to generate the message and by using the mismatch data, and received from a location remote from the vehicle.

13. The vehicle of claim 11, wherein the at least one processor is arranged to operate by: using a database of contextual information that lists which basis data is to be considered when determining the mismatch of an individual alert, and displaying categories of the basis data of the alert in the vehicle.

14. The vehicle of claim 11, wherein categories of basis data are displayed upon a request through a user interface on the vehicle.

15. The vehicle of claim 11, wherein the vehicle is an aircraft, and wherein the at least one processor is arranged to operate by changing an image of an avionics system value to attempt to make the avionics system value more noticeable on a display device in the aircraft and that is one reason for the alert, and changed on an avionics page that is arranged to display the avionics system value during a run-time of the aircraft.

16. A system, comprising:
a vehicle, comprising:
a display device to display alerts; and
first processor circuitry forming at least one first processor arranged to operate by:
generating an indication of an alert of an undesirable event associated with the vehicle,
announcing the alert on the display device, and
automatically transmitting the indication of the alert and basis data used to trigger the alert; and
a remote system remote from the vehicle, comprising:
memory; and
second processor circuitry forming at least one second processor communicatively coupled to the memory, and being arranged to operate by:
receiving the indication and the basis data;
automatically determining root cause mismatch data that indicates conditions that formed an immediate cause of the alert and by using the alert and the basis data, wherein the mismatch data comprises a mismatch of vehicle data between data related to an expected action or inaction of the vehicle and data related to an actual action or inaction of the vehicle; and
transmitting a message or message data to be used to generate the message and indicating the mismatch; and
wherein the at least one first processor at the vehicle is arranged to operate by:
receiving the message or message data; and
displaying the message on the display device indicating the mismatch.

17. The system of claim 16, wherein automatically determining root cause mismatch data comprises using a contextual information database associated listing different types of basis data associated with individual alerts and a root cause mismatch tree database that comprises root cause mismatch tree templates to populate one of the root cause mismatch tree templates with the alert and the basis data received from the vehicle.

18. The system of claim 16, wherein automatically determining root cause mismatch data comprises populating a root cause mismatch tree with a plurality of potential root causes each associated with a different contextual information type or different combination of contextual information types.

19. The system of claim 18, wherein a plurality of the root cause mismatch trees are provided each directed to a different type of alert.

20. The system of claim 18, wherein each node of the tree is associated with a comparison of expected values to actual values associated with at least one of the potential root causes or a comparison of actual values with one or more parameter thresholds automatically determining root cause mismatch data comprises populating a root cause mismatch tree with a plurality of the potential root causes each of a different contextual information type.
